(19) United States
(12) Patent Application Publication
(10) Pub. No.: US 2013/0329985 A1
(43) Pub. Date: Dec. 12, 2013

(54) GENERATING A THREE-DIMENSIONAL IMAGE

(71) Applicant: Jonas Helin, Gothenburg (SE)

(72) Inventor: Jonas Helin, Gothenburg (SE)

(73) Assignee: Microsoft Corporation, Redmond, WA (US)

(21) Appl. No.: 13/490,461

(22) Filed: Jun. 7, 2012

(51) Int. Cl. G06K 9/60

(52) U.S. Cl. 382/154

(57) ABSTRACT

Methods and systems for generating a three-dimensional image are provided. The method includes capturing an image and a depth map of a scene using an imaging device. The image includes a midpoint between a right side view and a left side view of the scene, and the depth map includes distances between the imaging device and objects within the scene. The method includes generating a right side image using the image and the depth map by calculating an appropriate location of each pixel within the image as viewed from the right side, and generating a left side image using the image and the depth map by calculating an appropriate location of each pixel within the image as viewed from the left side. The method also includes combining the right side image and left side image to generate a three-dimensional image of the scene and correcting the three-dimensional image.

### BACKGROUND

According to current techniques, three-dimensional (3D) images are created using two cameras. One camera may be used to record the perspective of the right eye, while the other camera may be used to record the perspective of the left eye. However, while this may produce high quality 3D images, it is not always feasible to use two cameras to record a scene. In many cases, it is desirable to produce 3D images from only one camera, or from other types of imaging devices.

### SUMMARY

The following presents a simplified summary of the innovation in order to provide a basic understanding of some aspects described herein. This summary is not an extensive overview of the claimed subject matter. It is intended to neither identify key nor critical elements of the claimed subject matter nor delineate the scope of the subject innovation. Its sole purpose is to present some concepts of the claimed subject matter in a simplified form as a prelude to the more detailed description that is presented later.

An embodiment provides a method for generating a three-dimensional image. The method includes capturing an image and a depth map of a scene using an imaging device, wherein the image includes a midpoint between a right side view of the scene and a left side view of the scene, and wherein the depth map includes distances between the imaging device and objects within the scene. The method also includes generating a right side image of the scene using the image and the depth map by calculating an appropriate location of each pixel within the image as viewed from the right side, and generating a left side image of the scene using the image and the depth map by calculating an appropriate location of each pixel within the image as viewed from the left side. The method further includes combining the right side image and the left side image to generate a three-dimensional image of the scene and correcting the three-dimensional image.

Another embodiment provides a system for generating a three-dimensional image, including a processor that is adapted to execute stored instructions and a storage device that stores instructions. The storage device includes processor executable code that, when executed by the processor, is adapted to obtain an image and a depth map of a scene from an imaging device, generate a right side image of the scene using the image and the depth map by calculating an appropriate location of each pixel within the image as viewed from the right side, and generate a left side image of the scene using the image and the depth map by calculating an appropriate location of each pixel within the image as viewed from the left side. The processor executable code is also adapted to combine the right side image and the left side image to generate a three-dimensional image of the scene, separate a foreground of the three-dimensional image from a background of the three-dimensional image, and overlay the foreground on top of a separate background.

Further, another embodiment provides one or more tangible, non-transitory computer-readable storage media for storing computer-readable instructions. When executed by one or more processing modules, the computer-readable instructions provide a system for generating three-dimensional images. The computer-readable instructions include code configured to obtain an image and a depth map of a scene from an imaging device, generate a right side image of the scene using the image and the depth map, and generate a left side image of the scene using the image and the depth map. The computer-readable instructions also include code configured to combine the right side image and the left side image to generate a three-dimensional image of the scene, separate a foreground of the three-dimensional image from a background of the three-dimensional image, and overlay the foreground on top of a separate background.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a computing device that may be used in accordance with embodiments;

FIG. 2 is a schematic of a camera that is configured to capture a 3D image of a scene including three objects;

FIG. 3 is a schematic of a view of the scene as perceived by the camera;

FIG. 4 is a schematic of a right side view of the scene;

FIG. 5 is a schematic of a left side view of the scene;

FIG. 6 is a process flow diagram showing a method for the generation of a 3D image; and

FIG. 7 is a block diagram showing a tangible, non-transitory computer-readable medium that stores code adapted to generate a 3D image of a scene.

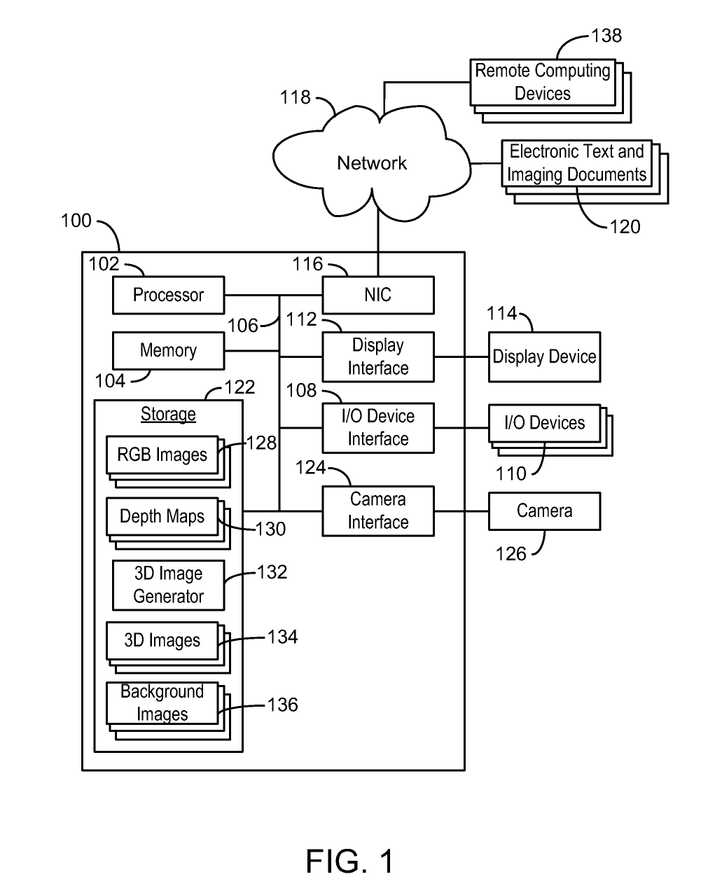

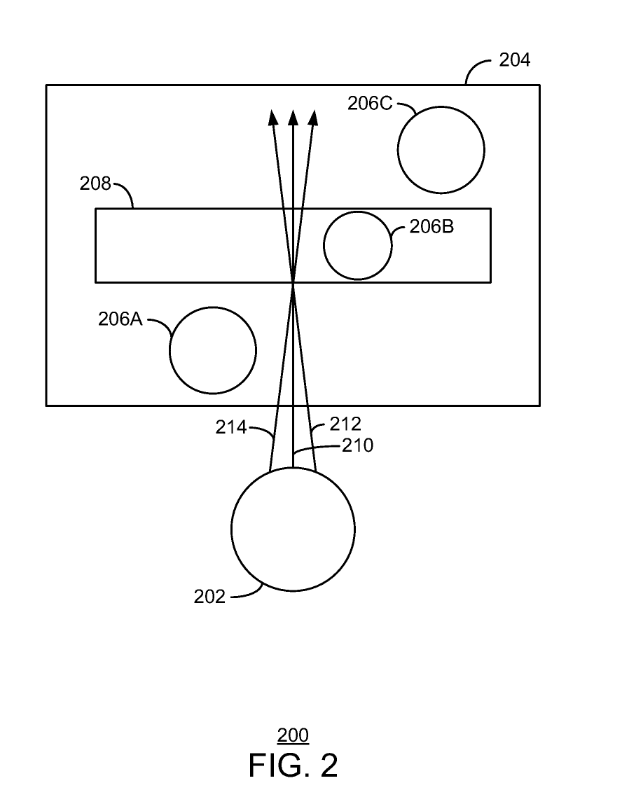

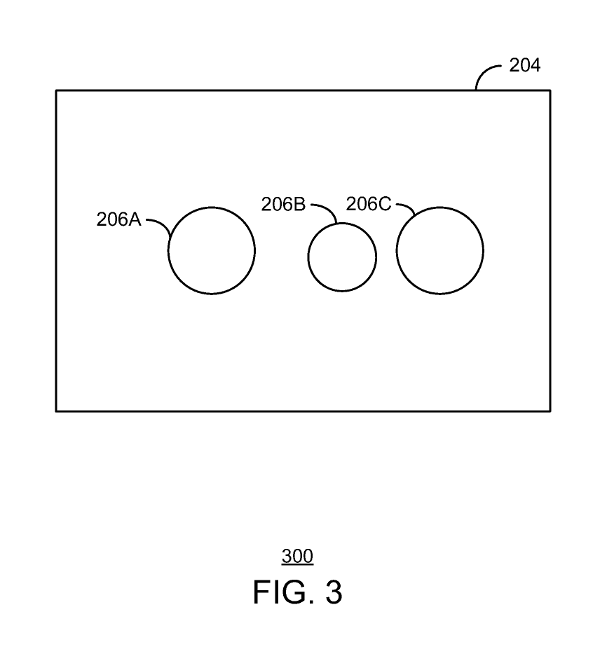

The same numbers are used throughout the disclosure and figures to reference like components and features. Numbers in the 100 series refer to features originally found in FIG. 1, numbers in the 200 series refer to features originally found in FIG. 2, numbers in the 300 series refer to features originally found in FIG. 3, and so on.

### DETAILED DESCRIPTION

As discussed above, it is not always feasible to use two cameras to record a scene but, rather, may be desirable to produce three-dimensional (3D) images from only one camera, or from other types of imaging devices. Therefore, embodiments described herein set forth a method and system for the generation of a 3D image of a scene, or portion of scene, using an RGB image and a depth map generated by an imaging device. The RGB image may represent the midpoint between a right side view and a left side view of the scene. In addition, the depth map may be an image that contains information relating to the distances from a camera viewpoint to the surfaces of objects in the scene.

The RGB image and the depth map may be used to create a left side image and a right side image. The left side image and the right side image may then be combined to generate the 3D image. In addition, the foreground of the 3D image may be separated from the background, and may be overlaid on top of another background.

In various embodiments, the method and system described herein provide for the generation of multiple 3D images from multiple locations using distinct imaging devices. The 3D images may be overlaid on top of a common background. This may enable remote collaboration between computing systems by creating the illusion that 3D images generated from remote computing systems share a common background or setting. Such remote collaboration may be useful for 3D remote video conferencing, for example.

As a preliminary matter, some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discrete logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

FIG. 1 is a block diagram of a computing device 100 that may be used in accordance with embodiments. The computing device 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory (RAM), read only memory (ROM), flash memory, or any other suitable memory systems. These instructions implement a method that includes generating a 3D image of a scene.

The processor 102 may be connected through a bus 106 to an input/output (I/O) device interface 108 adapted to connect the computing device 100 to one or more I/O devices 110. The I/O devices 110 may include, for example, a keyboard and a pointing device. The pointing device may include a touchpad, touchscreen, mouse, trackball, joy stick, pointing stick, or stylus, among others. The I/O devices 110 may be built-in components of the computing device 100, or may be devices that are externally connected to the computing device 100.

The processor 102 may also be linked through the bus 106 to a display interface 112 adapted to connect the computing device 100 to a display device 114. The display device 114 may include a display screen that is a built-in component of the computing device 100. The display device 114 may also include a computer monitor, television, stereoscopic 3D display, camera, projector, virtual reality display, or mobile device, among others, that is externally connected to the computing device 100.

A network interface controller (NIC) 116 may be adapted to connect the computing device 100 through the bus 106 to a network 118. The network 118 may be a wide area network (WAN), local area network (LAN), or the Internet, among others. Through the network 118, the computing device 100 may access electronic text and imaging documents 120. The computing device 100 may also download the electronic text and imaging documents 120 and store the electronic text and imaging documents 120 within a storage device 122 of the computing device 100.

The processor 102 may also be linked through the bus 106 to a camera interface 124 adapted to connect the computing device 100 to a camera 126. The camera 126 may include any type of imaging device that is configured to capture RGB images 128 and depth maps 130 of scenes. For example, the camera 126 may include an RGB camera that is configured to capture a color image of a scene by acquiring three different color signals, i.e., red, green, and blue. In addition, in some embodiments, the camera 126 includes a random dot pattern projector and one or more IR cameras that are configured to capture a depth map of the scene.

The storage device 122 can include a hard drive, an optical drive, a thumbdrive, an array of drives, or any combinations thereof. In various embodiments, the RGB images 128 and the depth maps 130 obtained from the camera 126 may be stored within the storage device 122. In addition, the storage device 122 may include a 3D image generator 132 configured to generate 3D images 134 based on the RGB images 128 and the depth maps 130. The storage device 122 may also include any number of background images 136.

Through the network 118, the computing device 100 may be communicatively coupled to a number of remote computing devices 138. In some embodiments, RGB images 128, depth maps 130, 3D images 134, or background images 136 may be downloaded from the remote computing devices 138, and may be stored within the storage device 122 of the computing device 100. In addition, the computing device 100 may transfer RGB images 128, depth maps 130, 3D images 134, or background images 136 to any of the remote computing devices 138 via the network 118.

It is to be understood that the block diagram of FIG. 1 is not intended to indicate that the computing device 100 is to include all of the components shown in FIG. 1. Further, the computing device 100 may include any number of additional components not shown in FIG. 1, depending on the details of the specific implementation.

FIG. 2 is a schematic 200 of a camera 202 that is configured to capture a 3D image of a scene 204 including three objects 206. The scene 204 includes a first object 206A that should be displayed in front of a television 208, a second object 206B that is in line with the television 208, and a third object 206C that is behind the television 208.

As shown in FIG. 2, a middle line 210 represents the line of sight of the camera 202. A right line 212 represents the line of sight from the right side. A left line 214 represents the line of sight from the left side. The right line 212 and the left line 214 are intended to model the lines of sight as viewed from a right eye and a left eye, respectively, of a viewer. Further, the middle line 210, the right line 212, and the left line 214 may represent three different views of the scene 204, as discussed further with respect to FIGS. 3-5.

FIG. 3 is a schematic 300 of a view of the scene 204 as perceived by the camera 202. Like numbered items are as described with respect to FIG. 2. The schematic 300 shows the locations of the objects 206 within the scene 202 as perceived by the camera 202. The view of the scene 204 as perceived by the camera 202 may include the view represented by the middle line 210 described above with respect to FIG. 2.

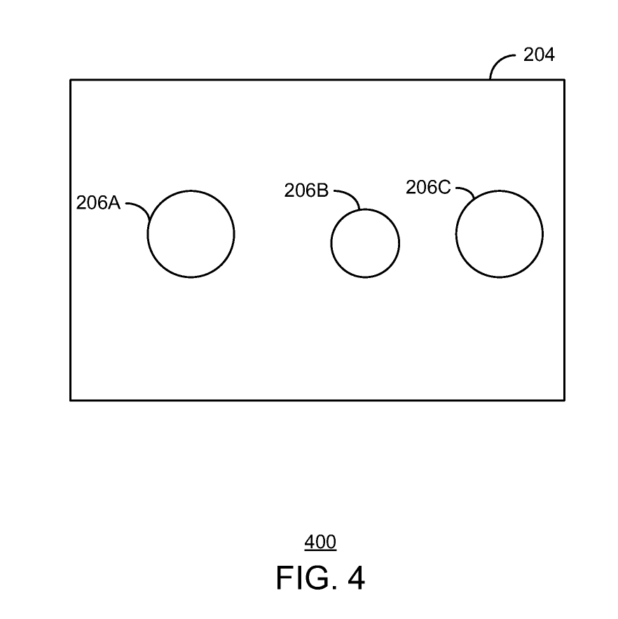

FIG. 4 is a schematic 400 of a right side view of the scene 204. Like numbered items are as described with respect to FIG. 2. The right side view of the scene 204 may include the view represented by the right line 212 described above with respect to FIG. 2. According to embodiments described herein, the right side view of the scene 204 is created by manipulating the view of the scene 204 as perceived by the camera 202. More specifically, for the right side view of the scene 204, the first object 206A, which is in front of the television 208, may be moved to the left. The third object 206C, which is behind the television 208, may be moved to the right. The second object 206B, which is the same plane as the television 208, may not be moved at all. In addition, in the case of a flat object, the further the object 206 is in front or behind the television 208, the further the object 206 is moved.

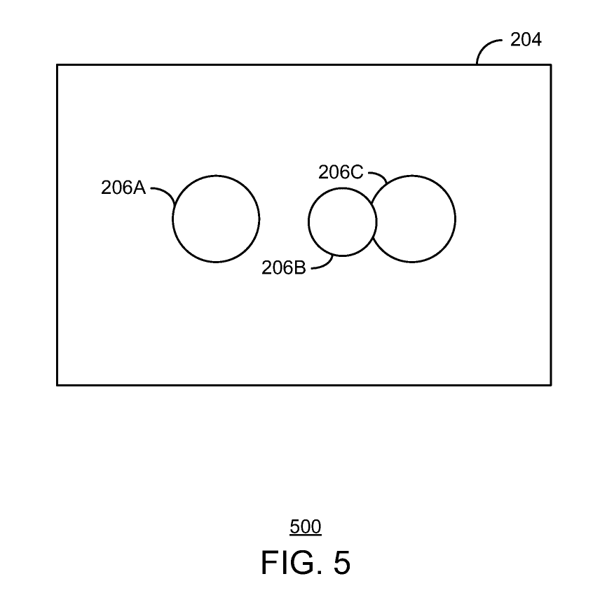

FIG. 5 is a schematic 500 of a left side view of the scene 204. Like numbered items are as described with respect to FIG. 2. The left side view of the scene 204 may include the view represented by the left line 214 described above with respect to FIG. 2. According to embodiments described herein, the left side view of the scene 204 is created by manipulating the view of the scene 204 as perceived by the camera 202. More specifically, for the left side view of the scene 204, the first object 206A, which is in front of the television 208, may be moved to the right. The third object 206C, which is behind the television 208, may be moved to the left. The second object 206B, which is the same plane as the television 208, may not be moved at all. In addition, in the case of a flat object, the further the object 206 is in front or behind the television 208, the further the object 206 is moved.

As discussed above with respect to FIGS. 4-5, the view of the scene 204 as perceived by the camera 202 may be manipulated to produce left side and right side views of the scene 204. This may be accomplished by looking at the depth distance between the television 208 and each object 206. If the object 206 is in front of the television 208, the object 206 is moved to the left for the right side view and to the right for the left side view. If the object 206 is behind the television 208, the object 206 is moved in the reverse direction. This technique may be applied to each pixel of an RGB image captured by the camera 202 in order to generate a right side image and a left side image of the scene 204. Then, the right side image and the left side image may be combined to obtain a 3D image of the scene 204.

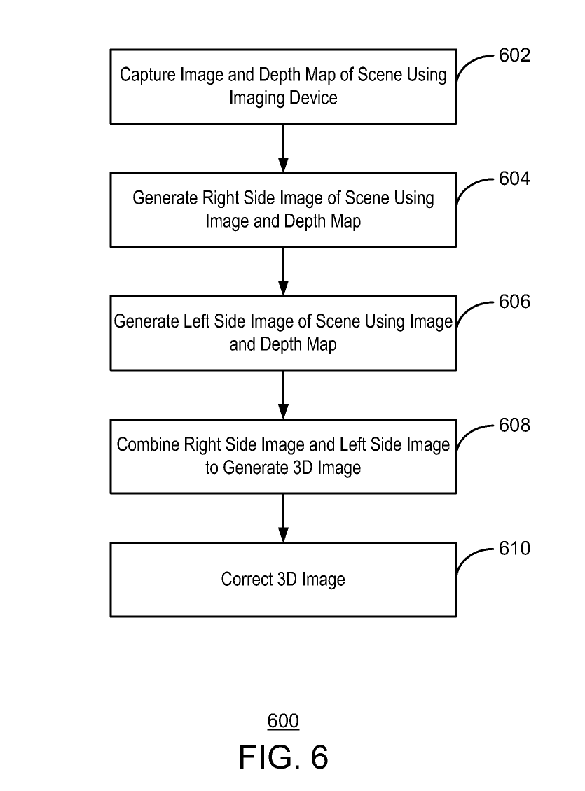

FIG. 6 is a process flow diagram showing a method 600 for the generation of a 3D image. In various embodiments, the method 600 is executed by the 3D image generator 132 of the computing device 100, as described above with respect to FIG. 1. Further, in some embodiments, the execution of the method 600 is controlled by a graphics processing unit (GPU) of a computing device.

The method begins at block 602, at which an image and a depth map of a scene are captured using an imaging device. The image may be an RGB image, and may be considered to be the midpoint between a right side view of the scene and a left side view of the scene. The depth map may include distances between the imaging device and objects within the scene.

The image and the depth map may be captured by an imaging device that is built into the computing device, or by an imaging device that is communicably coupled to the computing device. The imaging device may be any type of camera or device that is configured to capture the image and the depth map of the scene. In various embodiments, the imaging device may be positioned behind a user and in proximity to the head of the user. This ensures that the imaging device is capturing a view of the scene that is consistent with the view of the user.

At block 604, a right side image of the scene is generated using the image and the depth map. This may be accomplished by calculating the appropriate location of each pixel within the image as viewed from the right side. Each pixel within the image may be moved to the right or the left based on the depth location of the pixel.

At block 606, a left side image of the scene is generated using the image and the depth map. This may be accomplished by calculating the appropriate location of each pixel within the image as viewed from the left side. Each pixel within the image may be moved to the right or the left based on the depth location of the pixel.

The following code fragment may be used to generate the right side image and the left side image of the scene.

```
void TurnInTo3D(bitmap source, bitmap dest, float
  pixelsToMovePerMeter, float centerplane)
{
  per pixel
  {
    float thisPixelDepth = GetDepthForPixel(row, column)
    float thisPixelDeltaFromCenterPlane = (centerplane −
      thisPixelDepth)/100 (in meters)
    int pixelsToShiftToRight = thisPixelDeltaFromCenterPlane *
      pixelsToMovePerMeter
    ReadPixelFromSourcelmage(...)
    WritePixelToDestImage(move the pixel
    pixelsToShiftToRight)
```

The above code fragment may be applied to the image twice to generate both the right side image and the left side image. For the generation of the right side image, the parameter pixelsToMovePerMeter is negative, since pixels are to be moved in the reverse direction for the right side image as opposed to the left side image.

At block 608, the right side image and the left side image are combined to generate a 3D image. The right side image and the left side image may be combined according to the characteristics of the 3D display technology on which the 3D image is to be displayed. For example, for a 3D television, the two images may be shown side by side with shrunken widths. Thus, a number of different 3D images may be generated according to the method 600, depending on the types of 3D display technologies that are to be used.

At block 610, the 3D image is corrected according to any of a number of different techniques. For example, pixels within the image for which there is no image data may be smoothed based on surrounding pixels within the image. In addition, any of a number of different correction techniques may be used to approximate the background of a particular object. The approximated background may be used to fill in the hole in the image that is created when the object is moved to generate the right side image or the left side image.

In some embodiments, pixels for a portion of the background of the image that is covered by an object within the scene are approximated by averaging pixels in a surrounding portion of the background. For example, if a hand is positioned in front of a body and then is moved to the right, the hole in the background generated by moving the hand is likely to be more of the body. In addition, an average of the surrounding background pixels may be calculated to determine the appropriate pixels to fill in the hole in the background. The determination of which pixels are background pixels may be made using the depth map of the scene.

Previously-generated images of the scene may be used to determine portions of the background of the image for which there are no image data. In other words, images of the scene may be stored in memory, and the stored images may be used to determine the approximate pixels for portions of the background for which there are no image data. For example, if a person is standing in front of a background, the pixels for particular portions of the background may be recorded as the person moves around the scene. Then, the recorded background pixels may be used to fill in holes in the background that are created by moving objects. This technique may be particularly useful for instances in which the position of the camera has not changed, since the pixels for the background may be the same as those that were recorded in the past.

In addition, the depth map may be used to filter out pixels within the image that represent objects that are more than a specified distance from the imaging device. In other words, objects that are more than the specified distance from the imaging device may not be considered to be a part of the scene to be captured. For example, if a hand is in front of a body, it may be desirable to filter out the pixels relating to the body and only use the pixels relating to the hand. Thus, holes in the background may be not be important, since only certain objects may be considered.

Further, in various embodiments, the foreground of the 3D image is separated from the background of the 3D image. Then, the foreground of the 3D image may be overlaid on top of a separate background image. The foreground of the 3D image may be a specific object or group of objects within the 3D image. For example, the hand discussed above may be the foreground of the image, and the body may be the background. Thus, the pixels relating to the hand may be separated from the pixels relating to the body, and the pixels relating to the hand may be overlaid on top of an entirely different background.

The process flow diagram of FIG. 6 is not intended to indicate that the steps of the method 600 are to be executed in any particular order, or that all the steps of the method 600 are to be included in every case. Further, the method 600 may include any number of additional steps not shown in FIG. 6, depending on the details of the specific implementation. For example, in some embodiments, multiple 3D images are combined to create a 3D video. Such a 3D video may be used for 3D remote video conferencing applications or gaming applications, for example.

The 3D images may that are generated according to the method 600 may be viewed using any type of 3D display technology. For example, the 3D images may be displayed on a computer monitor, television, stereoscopic 3D display, camera, projector, virtual reality display, or mobile device, among others. In addition, in some embodiments, 3D glasses are used to view the 3D images on the 3D display technology.

In various embodiments, images and corresponding depth maps taken from different locations using different imaging devices are obtained from remote computing systems. A number of three-dimensional images may be generated from the images and the corresponding depth maps. A foreground of each three-dimensional image may be separated from a background of each three-dimensional image. The foreground of each three-dimensional image may be overlaid on top of a common background. In some embodiments, overlaying the three-dimensional images on top of the common background enables remote collaboration between the system and the remote systems from which any of the images and corresponding depth maps were obtained.

The 3D images that are generated according to the method 600 may be used for a variety of applications. For example, the 3D images may be used for 3D remote video conferencing. In some embodiments, remote participants may appear to be in the same room through the use of 3D images of the participants overlaid on top of a common background. The common background may be, for example, the environment of a particular participant or an artificial background.

The 3D images that are generated according to the method 600 may also be used for remote collaboration in computer applications. For example, the imaging device may be mounted over the surface of a display screen, such as a touchscreen of a computer, and the movement of the hand of the user may be captured by the imaging device. Then, a 3D image of the hand may be displayed to a remote user as if it is interacting with a remote display screen in the same manner. This technique may be used to enable remote users to collaborate on a particular project. For example, remote users may view an identical document, and may point to and discuss particular portions of the document as if they are in the same location. This technique may also be useful for any type of touch-enabled application in which a user desires to collaborate with a remote user. For example, this technique may be useful for gaming applications in which a user desires to see the specific actions of a remote opponent.

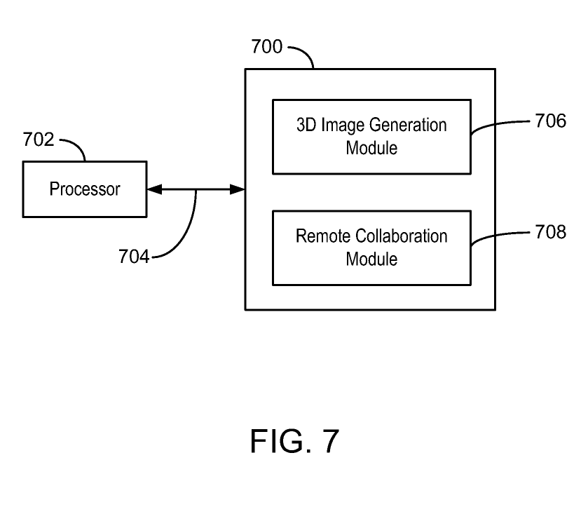

FIG. 7 is a block diagram showing a tangible, non-transitory computer-readable medium 700 that stores code adapted to generate a 3D image of a scene. The tangible, non-transitory computer-readable medium 700 may be accessed by a processor 702 over a computer bus 704. Furthermore, the tangible, non-transitory computer-readable medium 700 may include code configured to direct the processor 702 to perform the steps of the current method.

The various software components discussed herein may be stored on the tangible, non-transitory computer-readable medium 700 as indicated in FIG. 7. For example, a 3D image generation module 706 may be configured to generate a 3D image based on an RGB image and a depth map of a scene. In various embodiments, a right side image and a left side image are generated using the image and the depth map, and the right side image and the left side image are combined to generate the 3D image. In addition, the foreground of the 3D image may be separated from a background of the 3D image and may be overlaid on top of a different background.

A remote collaboration module 708 may be configured to allow interactions between remote computing systems by allowing for the overlaying of multiple 3D images on top of a common background. The 3D images may then be viewed as if they were captured from a same location, instead of from separate locations. This may be useful for many applications, such as 3D remote video conferencing applications and gaming applications. For example, the remote collaboration module 708 may be used to allow multiple people who are playing a game together from separate locations to feel as if they are playing the game together from the same physical location.

The block diagram of FIG. 7 is not intended to indicate that the tangible, non-transitory computer-readable medium 700 is to include all the components shown in FIG. 7. Further, the tangible, non-transitory computer-readable medium 700 may include any number of additional components not shown in FIG. 7, depending on the details of the specific implementation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating a three-dimensional image, comprising:
capturing an image and a depth map of a scene using an imaging device, wherein the image comprises a midpoint between a right side view of the scene and a left side view of the scene, and wherein the depth map comprises distances between the imaging device and objects within the scene;
generating a right side image of the scene using the image and the depth map by calculating an appropriate location of each pixel within the image as viewed from the right side;
generating a left side image of the scene using the image and the depth map by calculating an appropriate location of each pixel within the image as viewed from the left side;
combining the right side image and the left side image to generate a three-dimensional image of the scene; and
correcting the three-dimensional image.

2. The method of claim 1, wherein the method is executed by a graphics processing unit (GPU) of a computing device.

3. The method of claim 1, wherein correcting the three-dimensional image comprises smoothing pixels within the image for which there are no image data based on surrounding pixels within the image.

4. The method of claim 1, wherein correcting the three-dimensional image comprises approximating pixels for a portion of a background of the image that is covered by an object within the scene by averaging pixels in a surrounding portion of the background.

5. The method of claim 1, wherein correcting the three-dimensional image comprises using previously-generated images of the scene to determine portions of a background of the image for which there are no image data.

6. The method of claim 1, comprising using the depth map to filter out pixels within the image that represent objects that are more than a specified distance from the imaging device.

7. The method of claim 1, wherein correcting the three-dimensional image comprises separating a foreground of the three-dimensional image from a background of the three-dimensional image.

8. The method of claim 7, comprising overlaying the foreground of the three-dimensional image on top of a different background.

9. The method of claim 1, comprising using the three-dimensional image to enable remote collaboration between a user of a computing device on which the three-dimensional image is generated and one or more remote users.

10. A system for generating a three-dimensional image, comprising:
a processor that is adapted to execute stored instructions; and
a storage device that stores instructions, the storage device comprising processor executable code that, when executed by the processor, is adapted to:
obtain an image and a depth map of a scene from an imaging device;
generate a right side image of the scene using the image and the depth map by calculating an appropriate location of each pixel within the image as viewed from the right side;
generate a left side image of the scene using the image and the depth map by calculating an appropriate location of each pixel within the image as viewed from the left side;
combine the right side image and the left side image to generate a three-dimensional image of the scene;
separate a foreground of the three-dimensional image from a background of the three-dimensional image; and
overlay the foreground on top of a separate background.

11. The system of claim 10, wherein the image comprises a midpoint between a right side view of the scene and a left side view of the scene.

12. The system of claim 10, wherein the depth map comprises distances between the imaging device and objects within the scene.

13. The system of claim 10, wherein the processor executable code is adapted to:
obtain, from remote systems, images and corresponding depth maps taken from different locations using different imaging devices;
generate a plurality of three-dimensional images from the images and the corresponding depth maps;
separate a foreground of each of the plurality of three-dimensional images from a background of each of the plurality of three-dimensional images;
overlay the foreground of each of the plurality of three-dimensional images on top of a common background.

14. The system of claim 13, wherein the processor executable code is adapted to use the plurality of three-dimensional images overlaid on top of the common background to enable remote collaboration between the system and the remote systems from which any of the images and corresponding depth maps were obtained.

15. The system of claim 14, wherein the plurality of three-dimensional images comprises hands of users of the system and the remote systems, and wherein enabling the remote collaboration between the system and the remote systems comprises displaying the hands of the users on a display screen such that the hands appear to be floating over the display screen and interacting with the display screen.

16. The system of claim 9, wherein the processor comprises a graphics processing unit (GPU).

17. One or more tangible, non-transitory computer-readable storage media for storing computer-readable instructions, the computer-readable instructions providing a system for generating three-dimensional images when executed by one or more processing modules, the computer-readable instructions comprising code configured to:
obtain an image and a depth map of a scene from an imaging device;
generate a right side image of the scene using the image and the depth map;
generate a left side image of the scene using the image and the depth map;
combine the right side image and the left side image to generate a three-dimensional image of the scene;
separate a foreground of the three-dimensional image from a background of the three-dimensional image; and
overlay the foreground on top of a separate background.

18. The tangible, non-transitory computer-readable storage media of claim 17, wherein the computer-readable instructions comprise code configured to generate the right side image of the scene by calculating an appropriate location of each pixel within the image as viewed from the right side.

19. The tangible, non-transitory computer-readable storage media of claim 17, wherein the computer-readable instructions comprise code configured to generate the left side image of the scene by calculating an appropriate location of each pixel within the image as viewed from the left side.

20. The tangible, non-transitory computer-readable storage media of claim 17, wherein the computer-readable instructions comprise code configured to overlay the foreground of the three-dimensional image on top of a common background on which a plurality of separate three-dimensional images have been overlaid.
